(19) United States
(12) Patent Application Publication
(10) Pub. No.: US 2007/0034166 A1
(43) Pub. Date: Feb. 15, 2007

(54) StylePouch

(76) Inventor: Gwendolyn L. Brooks, El Cajon, CA (US)

Correspondence Address: McGahey & McGahey, APLC, 1532 Sixth Ave., San Diego, CA, 92101, US

(21) Appl. No.: 11/161,677

(22) Filed: Aug. 11, 2005

(51) Int. Cl. A01K 23/00

(52) U.S. Cl. 119/867

(57) ABSTRACT

Apparatus is disclosed for discreet compact light weight pouch for training, carrying objects and clean-up of pet waste wherein the user can carry treats, unused perforated roll waste bags in top flap cover compartment, and other items in another. The StylePouch is configured for independent use. A removable adjustable strap is provided and attached clip which functions to carry the pouch five different ways. Start-up accessories are included. The main compartment of the apparatus is the open and close pet paw to retrieve treats from the apparatus and insert a picture or ID that is protected by a clear plastic with lining to separate treats and contents. There is also a D-ring affixed to the back of the clip to attach miscellaneous objects.

### BACKGROUND OF THE INVENTION

### Field of the Invention

There are thousands of training and carrying devices in the art for training pets and carrying pet supplies as a separate unit. However, there aren't any comfortable compact light weight personal pet StylePouches, especially ones that have a clear plastic paw compartment that opens and closes for treats, another compartment to insert plastic, perforated, scented, rolled bags into a removable roll holder, and three more compartments with one lining, when removed the three compartments become one to store small and large items that can be removed one at a time as needed.

This invention relates generally to the field of pet training and carrying devices, specifically, devices that provides an improved clear pet paw, that opens and closes with a removable lining and a removable roll holder for plastic, perforated, scented roll waste bags, in which all are compartmentalized. Another important advantage of the StylePouch is the possibility of using each member (pet owners, groomers, overnight boarding, doggie daycare, and obedience training) as a separate and independent entity at the moment of need.

Therefore, it is an object of the present invention to provide a StylePouch for containing treats for easy access to the user when pet paw is opened, a lining which is removable for small and large pet supplies and the like, which is not cumbersome to the user and become one compartment and a top flap lid compartment for roll holder that have means to hold perforated plastic roll bags in place.

It is another device of the present invention when consistency is needed to provide and retrieve treat(s) when pet is with owner, in training, or away from home, with means to open and close pet paw with easy access. This is especially good for groomers, pet sitters, overnight boarders, daycare, and obedience training.

It is yet, another device of the present invention to carry other items used or necessary for walking, jogging, running, jumping, climbing or any type of sport activities or just laying on the beach.

Therefore in the art of training pets and carrying pet supplies and the like, the StylePouch have multiple easy accesses for the user anytime and anywhere. Use of the StylePouch would be very simple and straightforward. Most importantly, users will only need their pet(s) on the lease; this prevents the need for an additional purse or wallet.

### BRIEF SUMMARY OF THE INVENTION

The present invention is a pet personal compact light weight StylePouch for pet owners, groomers, overnight boarding, doggie daycare, pet sitters, obedience trainers, and individual use to carry pet treats, pet supplies, and picture or ID, that are important and necessary for their pet wherever they lay their paw.

The invention provides a clear cover and four dot circles connected to the pet paw that opens with a compartment inside for treats. It has a flap top cover with a roll holder for plastic, perforated, scented roll plastic bags, and a removable adjustable strap. Start-up accessories included. The back has an attached clip with a D-ring above it for miscellaneous objects. There are three compartments inside StylePouch with a removable lining that have means to hold small and large concealed items all in one compartment. The top flap compartment can be opened and closed through the use of Velcro.

The first compartment has a clear cover in front and back of the pet paw to insert a picture or ID. The clear plastic on the back of the pet paw protects the picture or ID from treat stains. The pet paw when open has a lining inside the compartment for easy access to retrieve treats and keep separate from other items. When the pet paw is closed, nothing is seen in front of the pet paw except a picture or ID. The StylePouch logo is located at the tip of the opening flap cover, so that the words StylePouch stands out.

The top flap cover of the second compartment has a roll-holder inside for perforated roll waste bags. The perforated, scented waste bags are to be inserted into the top flap cover for tearing off one at a time as needed. The perforated, scented roll waste bags is an extra accessory. When the top flap is closed nothing is seen on top or bottom of compartments.

The StylePouch was invented for pet owners, groomers, overnight boarding, doggie daycare, obedience trainers and individuals to have easier access to needed supplies and hands-free options when training their pet. The StylePouch is perfect for carrying items and accessories for their pets and personal use. The StylePouch can also be used for other pets such as cats, rodents, and birds etc.

Clearly, then, there is a need for a compact light weight StylePouch that can be worn comfortably so that the pet owner and others will have the easiest access to the contents for both pet and owner lifestyle and activities.

### BRIEF DESCRIPTION OF DRAWING

FIG. 1. is a front perspective view of the open clear cover pet paw showing, in particular, the embodiment where to insert a picture or ID inside the back of the pet paw, and the back compartment space pocket for gaining access to treats when pet paw is open.

FIG. 2 is a perspective view of the inside of first preferred embodiment of FIG. 1, whereas the top short flap is open for roll of waste bag (not visible in the figure) and two compartments within the interior chamber linings with the pet paw closed.

FIG. 3 is a perspective view of the back embodiment of FIG. 1, showing three D-rings, two on the side and one above the clip of StylePouch with back flap closed.

FIG. 4 is a side view of the StylePouch embodying the invention illustrated with the pet paw, short flap cover closed with the adjustable strap attached to D-ring and back clip.

FIG. 5 is a side view of the StylePouch embodying the invention illustrated with a view of the closed pet paw and short flap cover showing detached adjustable strap from D-ring.

FIG. 6 is a front view of the detached paw of the invention.

FIG. 7 is a perspective side view of the roll inside of the plastic, perforated, scented rolled waste bags.

FIG. 7a is a view of the waste bag when torn from the perforated waste bags roll.

FIG. 8 is a plan view of the front of the preferred embodiment of the present inventions.

### DETAILED DESCRIPTION OF THE INVENTION

Referring first to FIG. 1 Illustrates an open pet paw 100, affixed to the compartment 180 to hold treats. In the preferred embodiment in the back of the pet paw 160 hold picture or ID in place. In the preferred embodiment the first compartment 180 hold treats. The embodiment of the sidewalls 150 on the pet paw folds in and attaches to the Velcro 140 when closed. The oval shape 148 on short flap closed cover is for StylePouch logo. The embodiment of the StylePouch 110 illustrates a compact pouch with D-ring 112 attached on each side. The pouch 110 is preferably used to carry any pet items as well as treats for training and any other activities.

According to FIG. 1 embodiment the pet paw 100 is an addition and easier access to retrieve treats as well as inserting a picture or ID inside pet paw. It is compact and light weight for any lifestyle comfort.

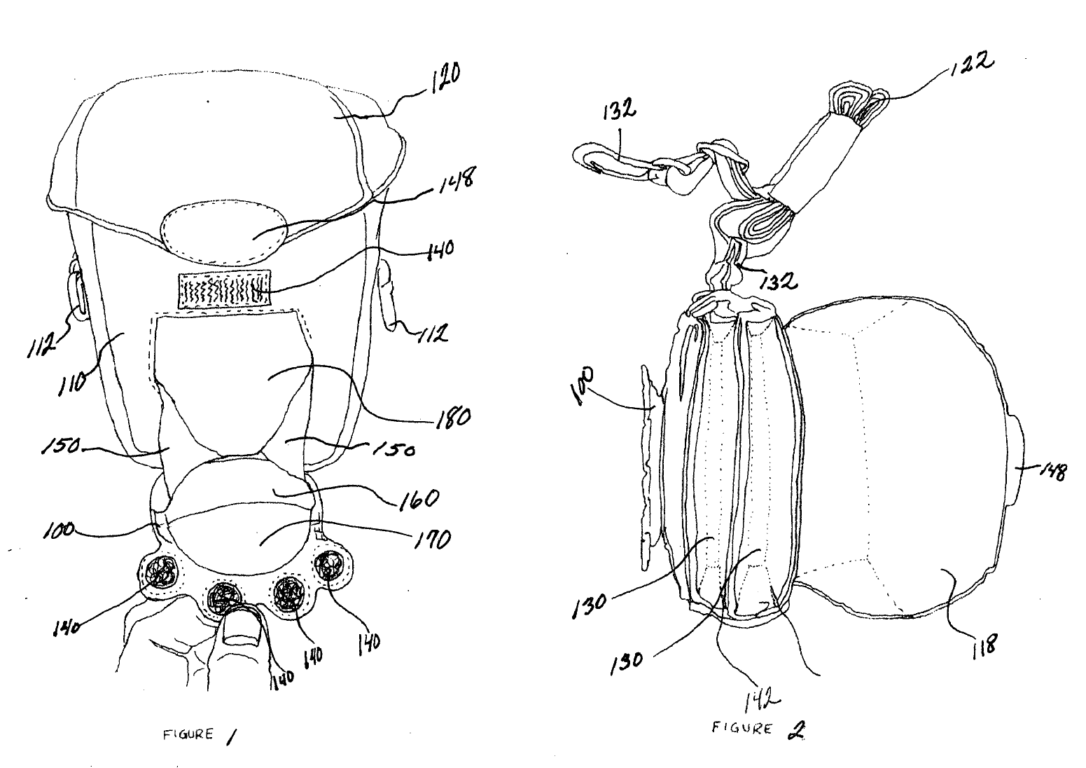

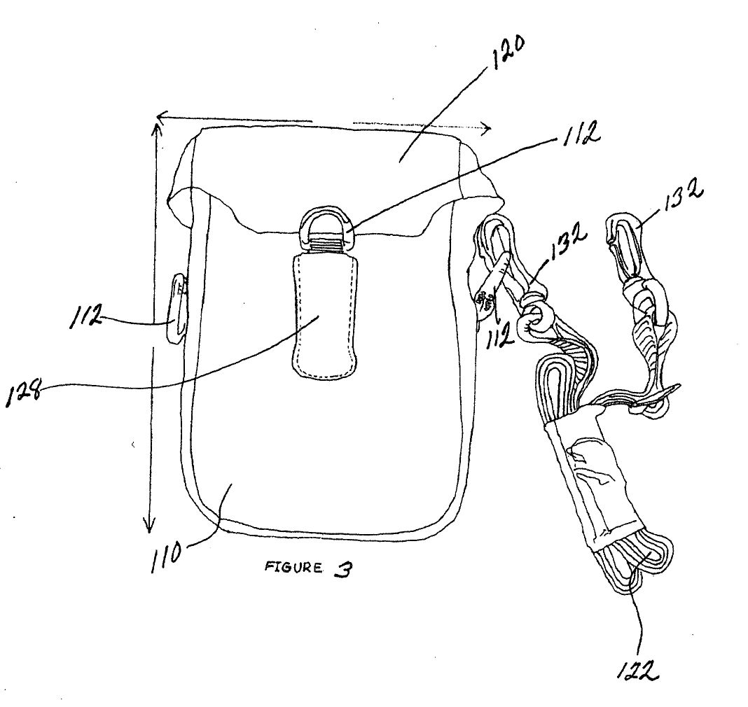

The second compartment has an open flap lid 118 in FIG. 2 to open and close to enable easy access to the plastic, perforated, scented roll waste bags (not shown) and to put items into the compartments 130 with removable linings 142 to make more room for larger items.

In the preferred embodiment FIG. 3, the back 110 has a clip with D-ring 128 and 112 with adjustable strap 122 having conventional hook 132 engagable with D-shaped ring on right side of back StylePouch 110 as shown in FIGS. 2 and 3, used for supporting pouch.

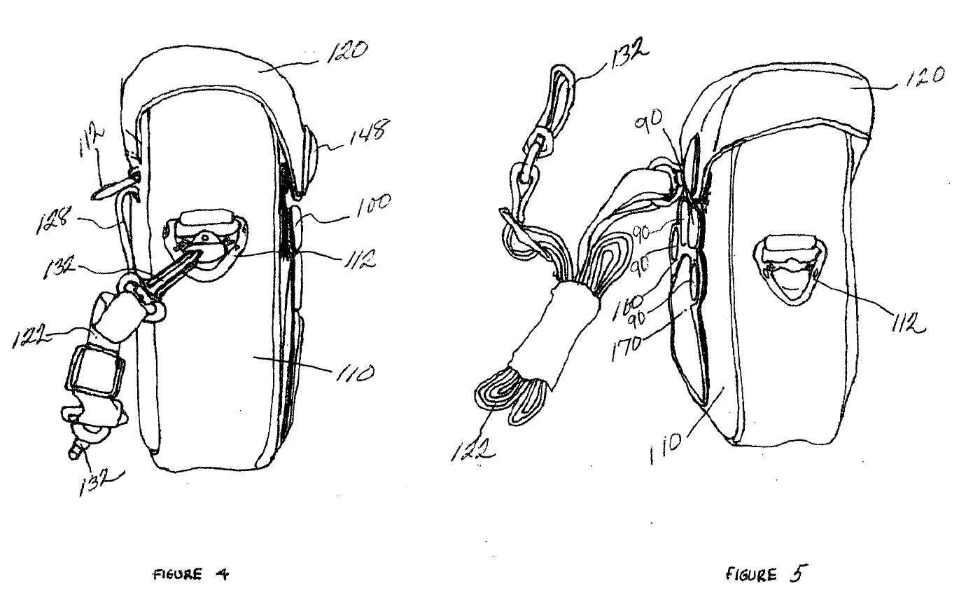

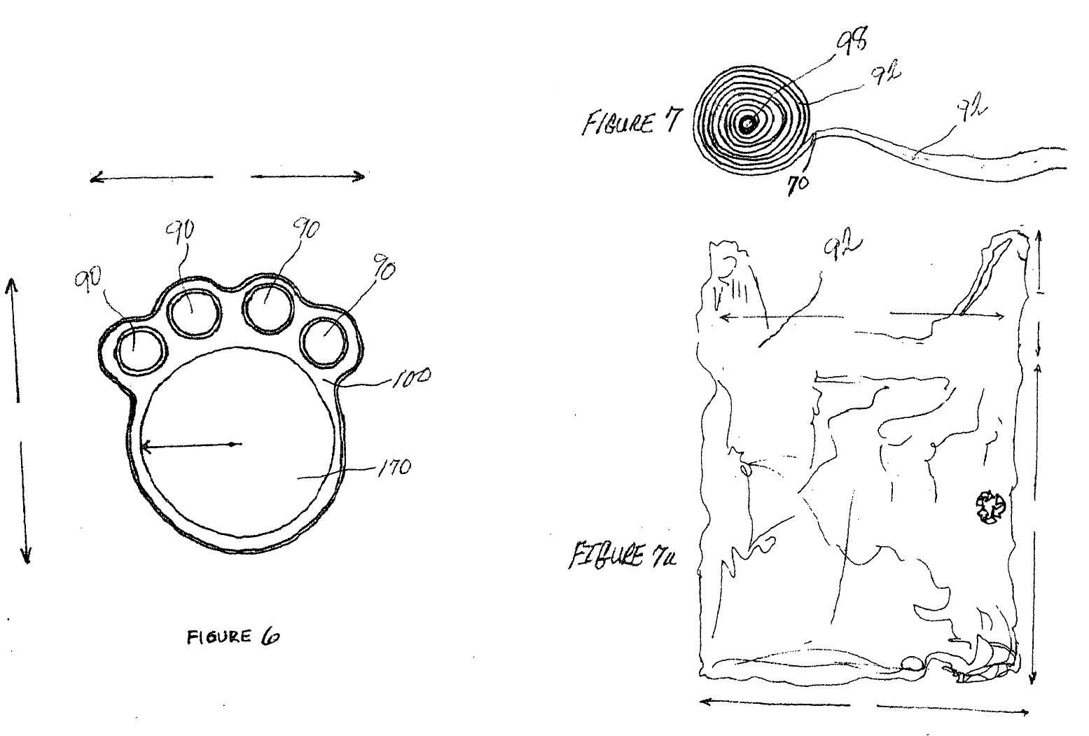

As shown in FIGS. 4-5, the embodiment of the StylePouch 110 side view with the pet paw 100 and paw circles 90.

FIG. 6 show the actual embodiment front look of the pet paw 100 with clear plastic cover 170 for picture or ID and four circles 90 that are in color which match with the StylePouch material.

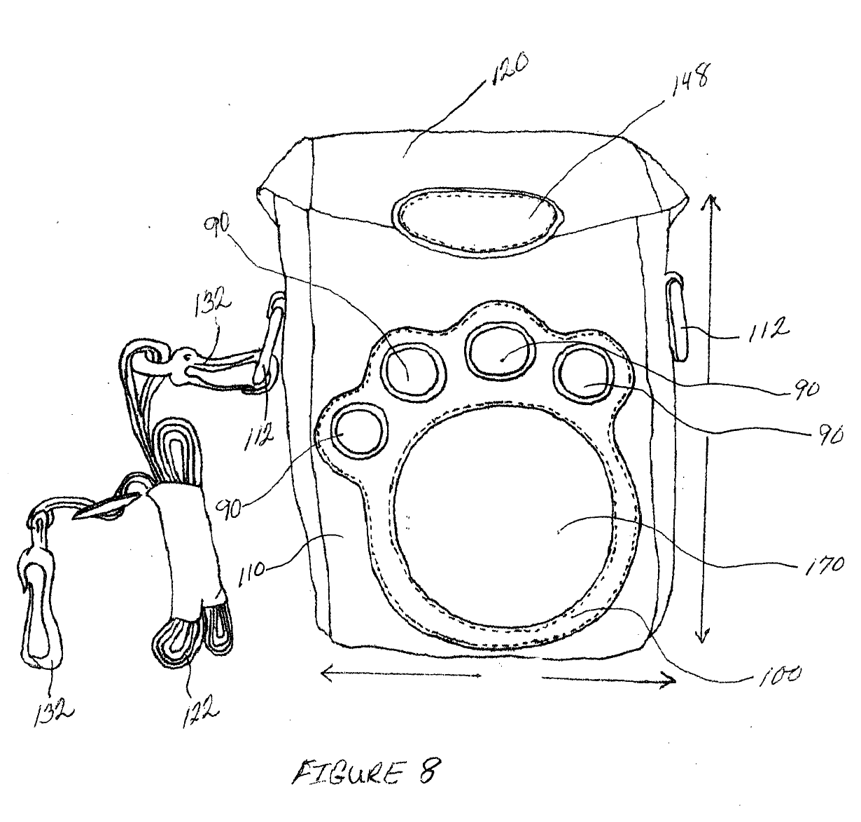

As shown in FIG. 7-7a, is the roll 98 that sits inside of top of flap cover after perforated waste bags roll 92 are inserted on roll 98. The embodiment of the plastic, perforated, scented waste bag 92 is shown in FIG. 7a when detached from perforated waste bags roll 70.

FIG. 8 shows the front a plan view of the preferred embodiment of the present invention the StylePouch 110, color dots 90, clear plastic for picture or ID 170, D-ring 112, oval shape 148 StylePouch name, cover flap 120, adjustable strip 122, hook 132, and closed pet paw 100.

The StylePouch is specifically designed to be compact. It has a cleverly designed paw that has a clear area for picture or ID and colored dog paw imprints for color coordination. The colors used are alluring. Each colored StylePouch is embedded with black interlay, showing a unique pattern of small interconnected colored squares highlighted by black. All of the StylePouch pouches are water resistant.

The invention may be manufactured to include visual indicia, which can either be commercially purchased or custom made. Such indicia may consist of a pet motif, or alternatively, may incorporate a photograph of an owners' pet, or a pet's name, as through embroidery.

Additional embodiments will become apparent to those skilled in the arts to which it pertains without deviating from the scope from the appended claims. The claims, figures, and detailed descriptions of the invention are illustrative of a particular embodiment, but should not be considered as limiting other embodiments, which may be resorted to without departing from the invention. Thus, the detailed description and the figures above should not be construed as limiting the scope of the inventions.

### CROSS REFERENCE TO RELATED APPLICATIONS

There are several prior patented interest and their solutions are as follows:

| | U.S. Pat. No. | Date |
|---|---|---|
| Ringelstetter | 6,257,473 | Jul. 10, 2001 |
| Hess | 5,560,321 | Oct. 01, 1996 |
| Roe | 5,363,809 | Nov. 15, 1994 |
| Nevitt | 5,184,762 | Feb. 09, 1993 |
| Lindsey | 5,233,942 | Aug. 10, 1993 |
| Conboy | 5,727,500 | Mar. 17, 1998 |

The Ringelstetter patent discloses a sanitary pet-waste collection pouch including an interior open-topped chamber or holding tied loaded plastic bags containing retrieved pet-waste, the pouch having a flap portion carrying interior and exterior opening pockets on opposite sides thereof, a pair of deep side-pockets on opposite sides of the chamber, releasable retaining loops coupled to the respective deep side-pockets on opposite sides of the chamber, releasable retaining loops coupled to the respective deep side-pockets, the interior opening pocket carrying a supply of plastic litter bags and the exterior opening pocket carrying personal effects, releasable retainer loops coupled to the deep side-pockets and each formed of a strip carrying opposite sided “hook” and “pile” portions which are engaged to form the loop, “hook” and “pile” portions being self-engagable forming the loops, and pockets on opposite sides thereof. The flap portion carries a horizontal “hook” portion and is fitted over the open interior chamber and engages a “pile” portion applied to the outer wall of the pouch at a location angular to the “hook” portion, the engagement being adjustable at any location along the length of said “pile” portion dependent upon the girth of the pouch.

The Hess patent discloses a pouch-like dog waste carrier and plastic bag dispenser arrangement comprising a pair of pockets on either side of a dog harness to be worn by the dog. One pocket carries a dispenser box holding plural folded plastic litter bags. The dispenser box and one pocket have matching slots through which the litter bags can be dispensed one at a time. The other pocket, absent the slot, is employed to hold “loaded” plastic litter bags tied, closed and introduced therein. The pocket intended to carry the “loaded” plastic bags has a flap which is secured, via a “hook and pile” Velcro combination closure on the flap and the exterior body of said pocket. (“Velcro” is a trademark of Velcro International Inc.) There are no additional pockets for carrying items other than the empty liter bags and waste-filled litter bags. Rather than being conveniently secured to the animal's collar, the unit would have to be fitted onto the harness worn by the animal for each excursion, walk, etc.

Roe patent provides a carrier comprising a pair of open-ended pouches formed by a hollow sheath bound mid-length in the form of a “bow-tie” by a band or knot to create a pair of the opposite open-ended pockets. At least one of the pockets can be sealed with “hook and pile” fastening means to close off the open ends thereof. The “Velcro” closure or closures are inner positioned for sealing purposes. A self-locking plastic strap is interfaced with the “bow-tie” knot and can be secured to the animal's collar or to a leash. The Roe carrier, when worn by the animal, soon would become unbalanced and difficult for the animal to wear. There is some question as to the capacity of the Roe holders and the ability of the holder to retain the feces in the feces-loaded litter bags even when the open top of the holder is secured together but not sealed about its opening.

Nevitt patent provides a harness secured to the animal. The harness have a strap to which are attached sever holders for carrying containers such as cylindrical beverage containers and also includes a loop attachable to a leash. This unit does not dispense or carry litter bags, whether loaded or empty. This patent is similar to Hess in that a harness is provided which carries containers, but Nevitt carries only beverage cans rather than containers respectively intended to carry fresh litter bags and loaded fecal waste bags reactively.

Cooper describes a leash holder assembly that is removable mountable to the collar of a pet, and including a leash holder made of flexible material and having face-to-face rectangular panels that are stitched along their bottom and side edges in such a manner to provide an open-topped pouch for storing a leash in coiled-up condition, and including a rectangular closure flap that can fold over the top of the pouch to close the pouch, Velcro fastening elements used to secure the closure flap. Velcro equipped tabs secure the holder to the pet collar and the leash is attached at one of its ends to the collar and the handle of the stored leash protrudes through an opening in the pouch. The leash is quickly deployable when required by grasping the handle and pulling it away from the pouch so that the leash uncoils from the grasp of the pouch.

In Conboy, the front pouch has a top opening but remains folded until used. The front pouch receives the waste-loaded closed end and tied litter bags when the pouch is unfolded. The “hook and pile” Velcro-type closure is positioned at the lower exterior closed end of the front pouch to support the front pouch in folded condition. The storage device can be used for holding useful pet-related items such as pet-toys, pet-medication, water container, etc., when not used for carrying the waste-loaded litter bags. However, there is no provision for carrying any of these items in either of the front or rear pouches if one or the other or both are used to carry waste-loaded litter bags. The Conboy storage device must be hand-carried by the hand loop of the leash and cannot be carried by the animal.

Many designs and configurations are represented, with attractiveness, ease of use, portability, ease of content organization and usable capacity relative to overall size being advantageous factors and is well known in the prior art. The StylePouch is a compact, light weight pouch that all pet users can carry objects and treats as well as discreet clean-up items. The StylePouch is accessible for all pet type activities not just one thing. The StylePouch was invented for individual use for pet owners, groomers, pet sitters, overnight boarding, doggie daycare, and obedience trainers. Recently, attention has been given to light weight compact opening and closing pet paw with an assessable compartment to retrieve treats. Star-up accessories are included with the StylePouch.

What is claimed is:

1-11. (canceled)

12. A device for training and caring for pets comprising:
(a) a pouch with a bottom and a plurality of sides holding animal treats which is open at the top;
(b) an external opening in one vertical side of the lower one half of the pouch;
(c) a side flap of a sufficient size to cover the external opening;
(d) The side flap connected by a flexible hinge means between the side flap's bottom edge and the exterior of the bottom of the pouch in a location which will allow the side flap to move vertically so as to close and seal the external side opening;
(e) two separate flexible side curtains, one on each vertical edge of the side flap connecting each vertical edge of said side flap to the area of the pouch directly across from it in such a location that it will prevent pet treats from falling out of the pouch when the side opening is open.
(f) a means to temporarily secure the top of the side flap to the pouch so the treats cannot be reached when the side flap is closed;
(g) a top lid to close the open top of the pouch;
(h) a means for securing the pouch to the person wearing it.

13. The device of claim 12 wherein there are three adjustable sized pockets inside the pouch connected to the interior of the pouch by a Velcro means which can be adjusted in size to fit valuables placed inside the pouch.

14. The device of claim 12 wherein the side flap covering the compartment is in the shape of an animal paw.

15. The device of claim 12 wherein the exterior of the side flap has a transparent outer cover in which visual information can be placed.

16. The device of claim 12 wherein the top lid contains a holder for a roll of disposable bags for holding pet refuse and feces.

17. The device of claim 12 wherein a small bottle of hand sanitizer is anchored by an anchor means to the outside of the pouch.

18. The device of claim 12 wherein the means for securing the pouch to the person wearing it is by a clip means.

19. The device of claim 12 wherein the means for securing the pouch to the person wearing it is by an adjustable strap.

20. The device of claim 12 wherein the means for securing the side flap to the pouch when in the closed position so that treats do no fall out is two pieces of Velcro material.
